(19) United States
(12) Patent Application Publication
(10) Pub. No.: US 2003/0141290 A1
(43) Pub. Date: Jul. 31, 2003

(54) Lightwave oven with elliptical-parabolic lamp reflector

(76) Inventors: Martina Backer, Traunreut (DE); Wolfgang Fuchs, Altenmarkt A.D.Alz (DE); Bernhard Herold, Regensburg (DE); Katrin Horn, Traunreut (DE); Kurt Lintner, Nussdorf (DE); Andreas Nitschke, Tacherting (DE); Martin Schulte, Hagen (DE); Martin Thaler, Oberteisendorf (DE)

Correspondence Address: LERNER AND GREENBERG, P.A., POST OFFICE BOX 2480, HOLLYWOOD, FL, 33022-2480, US

(21) Appl. No.: 10/356,920

(22) Filed: Jan. 30, 2003

(30) Foreign Application Priority Data
Jan. 30, 2002 (DE) 102 03 605.5

(51) Int. Cl. F27D 11/00

(52) U.S. Cl. 219/405; 219/411; 392/416

(57) ABSTRACT

A lightwave oven includes a lightwave heating device having at least one radiant lamp and at least one reflector having a reflective surface whose geometric shape is formed by a generatrix. Improved thorough cooking and browning of food in the oven is achieved by using a common radiant lamp both for browning and for cooking, its reflector having a reflective surface produced from a generatrix having a curve lying between an elliptical and a parabolic curve, whose vertices lie at a common first point and whose focal points lie at a common second point.

### BACKGROUND OF THE INVENTION

### Field of the Invention

The invention relates to a lightwave oven having a lightwave heating device, which includes at least one radiant lamp and a reflector, the reflector having a reflective surface whose geometric shape is formed by a generatrix.

Lightwave ovens are ovens that heat the food by visible and infrared radiation. As a result of the action of visible, almost visible, and infrared radiation of high intensity on the food, a very rapid and high-quality cooking and baking method is provided. The cooking times are approximately of the time frame that is known from the use of microwave ovens, browning being obtained as is known from conventional ovens.

A lightwave oven is disclosed, for example, from International publication WO 95/32396 A1, corresponding to U.S. Pat. Nos. 5,674,421 to Beaver II et al. and to 5,534,679 to Beaver II et al. In the case of such an oven, the food support includes a plate that is open at the front and provided with three side walls and that has a central opening, into which a metal grid can be inserted that is used for the actual holding of the food. The metal grid can be rotated over rollers disposed underneath the plate so that the food can be moved relative to the light/radiant source. The door for closing the opening in the oven housing, from which the food support can be moved out, is constructed as a pivoting door that is opened or closed by the movable food support. In the prior art lightwave ovens, the light/radiant sources used are tungsten quartz halogen lamps, such as quartz arc lamps.

### SUMMARY OF THE INVENTION

It is accordingly an object of the invention to provide a lightwave oven with elliptical-parabolic lamp reflector that overcomes the hereinafore-mentioned disadvantages of the heretofore-known devices of this general type and that improves thorough cooking and browning of the food.

With the foregoing and other objects in view, there is provided, in accordance with the invention, a lightwave oven, including a lightwave heating device having at least one radiant lamp and at least one reflector having a reflective surface in a geometric shape formed by a generatrix, the generatrix having a curve lying between an elliptical curve having a first vertex and a first focal point and a parabolic curve having a second vertex and a second focal point, the first and second vertices lying at a common first point, and the first and second focal points lying at a common second point.

With the objects of the invention in view, in a lightwave heating device of a lightwave oven having at least one radiant lamp, there is also provided a lamp reflector including at least one reflector body having a reflective surface in a geometric shape formed by a generatrix having a curve lying between an elliptical curve having a first vertex and a first focal point and a parabolic curve having a second vertex and a second focal point, the first and second vertices lying at a common first point, and the first and second focal points lying at a common second point.

It may be expedient to equip the radiant lamps of the lightwave oven with reflectors of different geometry. A reflector that has an elliptical curve as generatrix is used, in particular, to concentrate the light emitted by the associated radiant lamp at a focus. At the focus, the emitted light energy is concentrated onto a small area. Therefore, particularly with regard to browning the food, it is expedient to equip a radiant lamp with a reflector that additionally concentrates the light energy, as a result of which more rapid and more intensive browning is achieved. For browning, it is, thus, in particular, expedient to equip the radiant lamp with a reflector whose geometry is formed by a generatrix that is an elliptical curve.

For thorough cooking, it is desirable if the deeply penetrating light energy is distributed as uniformly as possible in the food so that the food is cooked to the same extent at all internal points. A reflector that has a parabolic curve as the generatrix is used, in particular, to output the light emitted by the associated radiant lamp in parallel beams. The light energy emitted is, therefore, not concentrated onto a small area but distributed very uniformly over a large area. Therefore, for thorough cooking of the food, it is, in particular, expedient to equip a radiant lamp with a reflector that distributes the light energy very uniformly, by which measures uniform thorough cooking of the food is achieved. For thorough cooking, it is, therefore, in particular, expedient to equip the radiant lamp with a reflector whose geometry is formed by a generatrix that is a parabolic curve.

If no separate radiant lamps are provided for browning and thorough cooking, a common radiant lamp has to be used both for browning and for cooking. If such a radiant lamp is associated with a lamp reflector, the latter should also meet both requirements if possible.

The object of improving thorough cooking and browning of the food is achieved by the generatrix of the reflective surface of the reflector having a curve that lies between an elliptical and a parabolic curve, whose vertices lie at a common first point and whose focal points lie at a common second point.

By selecting a reflective surface for the reflector that is generated neither purely elliptically nor purely parabolically, a compromise is found that meets both the requirements on the browning of the food as a result of adequate focusing of the lightwaves, and also, the requirements on the thorough cooking of the food as a result of the most uniform possible distribution of the lightwaves.

The reflector according to the invention has a reflector surface whose generatrix is determined in the following way:

The ellipse equation is: (yₑ²/b²)+(xₑ²/a²)=1.

The parabola equation is: yₚ²=2*pₚ*(cₚ−xₚ).

The boundary conditions are: a=cₚ and pₚ/2=a−e, where e²=a²−b².

One possibility for combining the curves is to proceed as set forth in the following text.

The starting point for the two curves is the vertex: (xₒ;yₒ)=(a;0)=(cp;0).

The further curve points (xᵣ;yᵣ) are determined as set forth in the following text.

One point on the ellipse is chosen: (xₑ;yₑ). For this pair of values, the associated arc length sₑ is calculated with the equation:

$${s}_{e} = {\int }_{( a ; O )}^{( x , y )} \sqrt{1 + {y}^{′} ( x )} ⅆ x with ( x ; y ) = ( {x}_{e} ; {y}_{e} ) .$$

The pair of values (xₚ;yₚ) for the parabola is, then, calculated, the following relationship being true for its arc length sₚ:

$${S}_{p} = {\int }_{( c ; 0 )}^{( x ; y )} \sqrt{1 + {y}^{′} ( x )} ⅆ x = {s}_{e} with ( x ; y ) = ( {x}_{p} ; {y}_{p} ) .$$

The curve points (xᵣ;yᵣ) are then given by:

Xᵣ=xₑ; and

yᵣ=(f*Yₑ+g*yₚ)/(f+g),

Here, f denotes the shape factor for the ellipse and, in a preferred embodiment of the invention, is equal to 1. The shape factor for the parabola is denoted g and, in a preferred embodiment of the invention, is equal to 3.

The curve obtained is used as a generatrix for the reflector surface. If spherical radiant lamps are used, the reflector surface is generated by rotation of the generatrix about the axis of symmetry of the generatrix. If rod-like radiant lamps are used, the reflector surface is produced by a translational displacement of the generatrix in the direction at right angles to the surface in which the generatrix lies.

In accordance with an added feature of the invention, the radiant lamp is a tubular rod lamp and the reflector is a channel-shaped body having a reflective surface in a geometric shape defined by a translational displacement of the generatrix in a direction at right angles to a surface in which the generatrix lies.

The rod-like radiant lamp is, preferably, positioned in relation to the reflector such that the radiant lamp lies at the focal point of the generatrix of the reflector or lies at least approximately at the focal point of the generatrix of the reflector.

In accordance with another feature of the invention, the at least one reflector is disposed with respect to the radiant lamp to place the radiant lamp at least approximately at the common second point of the generatrix.

In accordance with a concomitant feature of the invention, the radiant lamp is disposed at least approximately at the common second point.

An elliptical-parabolic reflector according to the invention, therefore, provides both relatively good focusing of the lightwaves emitted by the radiant lamp and, at least in a relatively large distance range, a virtually constant radiation distribution.

Other features that are considered as characteristic for the invention are set forth in the appended claims.

Although the invention is illustrated and described herein as embodied in a lightwave oven with elliptical-parabolic lamp reflector, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective view of an oven housing of a lightwave oven according to the invention having a lightwave heating device that can be moved to and fro;

FIG. 2 is a schematic cross-sectional view through the lightwave oven of FIG. 1;

FIG. 3 is a diagrammatic illustration of a generatrix for a lamp reflector according to the invention; and

FIG. 4 is a graph of elements of a parabola and an ellipse according to the invention in the Cartesian coordinate system.

### DESCRIPTION OF THE PREFERRED EMBODIMENTS

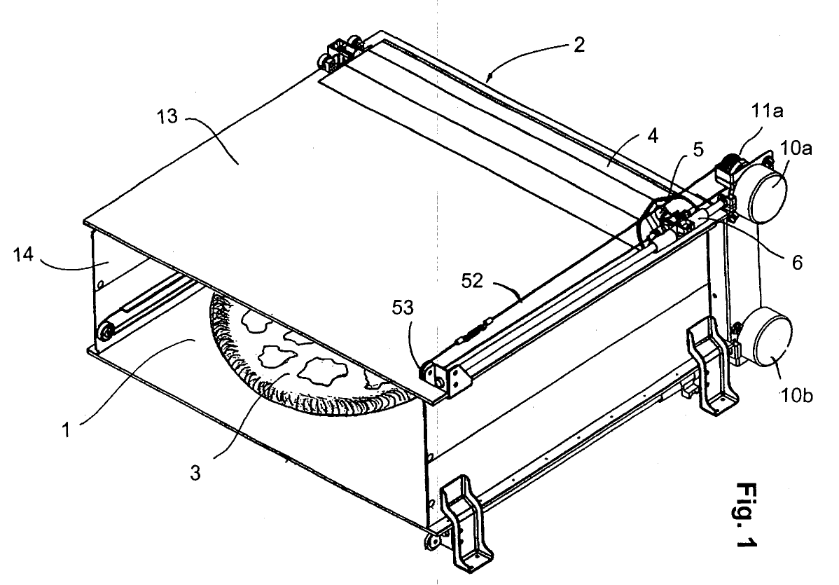

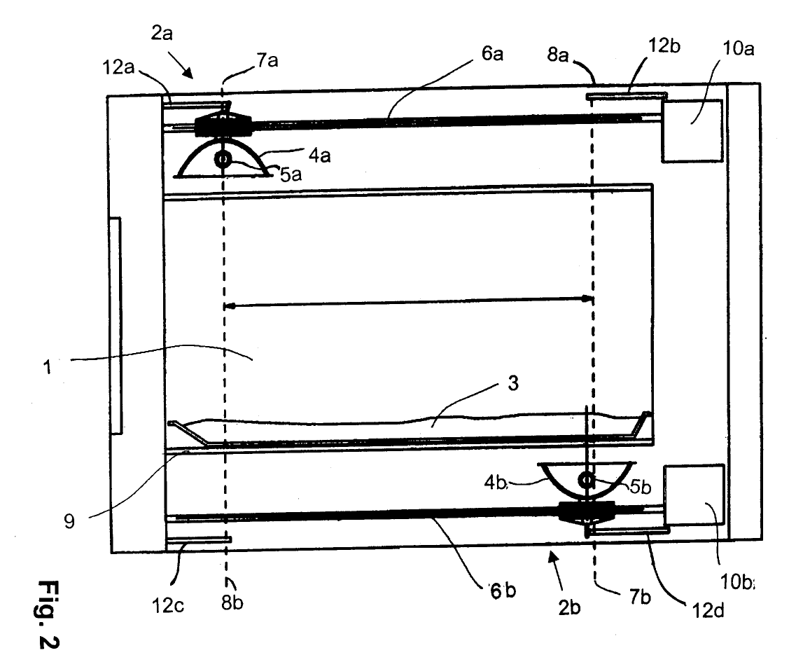

Referring now to the figures of the drawings in detail and first, particularly to FIG. 1 thereof, there is shown a configuration of a lightwave oven with a lightwave heating device that can be moved to and fro. A cooking chamber 1 is enclosed by an oven housing 13 and, at its front side, has an opening 14 for food 3 to be put into the cooking chamber 1. Above the cooking chamber 1 and underneath the cooking chamber 1 (see FIG. 2), a lightwave heating device 2 that can be moved to and fro is disposed in each case. The lightwave heating device 2a disposed above the cooking chamber 1 includes an upper radiant lamp 5a and an upper lamp reflector 4a. The lightwave heating device 2b disposed underneath the cooking chamber 1 includes a lower radiant lamp 5b and a lower lamp reflector 4b. Each lightwave heating device 2a, 2b is fixed to its own movement device 6a, 6b such that it can be moved to and fro. The upper movement device 6a is driven through a pull cable 52 and a deflection roller 53 and an upper gear mechanism 11a by a stepping-motor 10a. The lower movement device 6b is driven in the same way as the upper movement device 6a but independently of the latter by a lower stepping motor 10b.

The schematic cross-section through the lightwave oven, illustrated schematically in FIG. 2, shows the cooking chamber 1 with the food 3 placed on a food support 9. The upper lightwave heating device 2a includes the radiant lamp 5a and the lamp reflector 4a. The lower lightwave heating device 2b includes the radiant lamp 5b and the lamp reflector 4b. The upper lightwave heating device 2a can be moved to and fro on a travel path from a first position 7a into a second position 8a by the movement device 6a. The movement device 6a is driven by the stepping motor 10a. The lower lightwave heating device 2b can be moved to and fro on a travel path from a first position 7b into a second position 8b by the movement device 6b. The movement device 6b is driven by the stepping motor 10b. A limit switch 12a provides a signal for reversing the movement of the upper lightwave heating device 2a in the first position 7a. A limit switch 12b provides a signal for reversing the movement of the upper lightwave heating device 2a in the second position 8a. A limit switch 12c provides a signal for reversing the movement of the lower lightwave heating device 2b in the second position 8b. A limit switch 12d provides a signal for reversing the movement of the lower lightwave heating device 2b in the first position 7b.

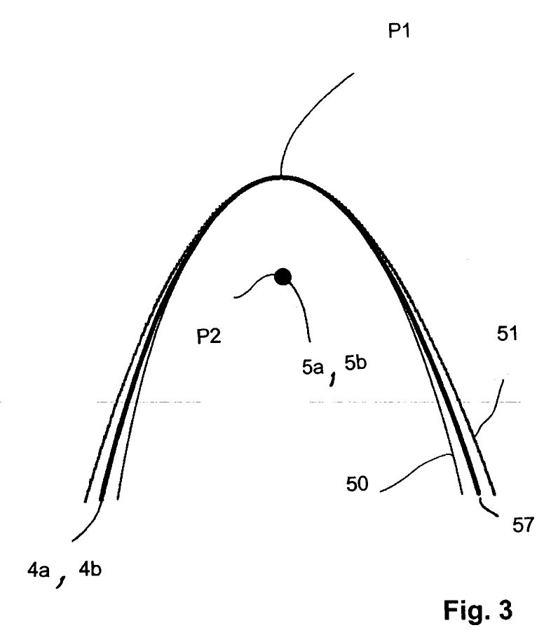

The illustration of FIG. 3 shows an elliptical-parabolic curve 57 as generatrix for the lamp reflectors 4a, 4b according to the invention. The elliptical-parabolic curve 57 lies between an elliptical curve 50 and a parabolic curve 51. Both the elliptical-parabolic curve 57 and the elliptical curve 50 and the parabolic curve 51 have a common vertex P1 and a common focal point P2. The lamp reflectors 4a, 4b are disposed in relation to the radiant lamps 5a, 5b such that each radiant lamp 5a, 5b lies at the focal point P2 of its associated lamp reflector 4a, 4b. The depth and the opening width of the lamp reflectors 4a, 4b can be defined in terms of the necessary dimensions by taking account of the size and the constructional conditions in the lightwave oven.

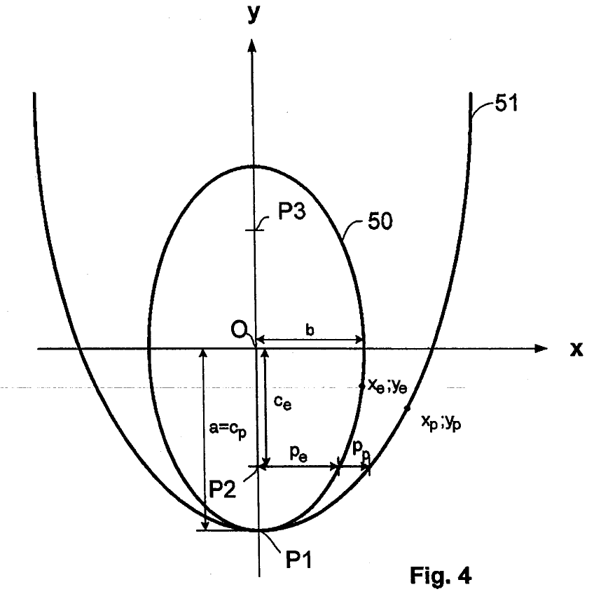

FIG. 4 shows the general elements of a parabola and of an ellipse. The elliptical curve 50 and the parabolic curve 51 have the common vertex P1 and the common focal point P2. The ellipse has a second focal point P3.

The distance from P2 to P3 defines the focal point spacing of the ellipse. The length of the focal point spacing of the ellipse is divided into two equally long partial distances cₑ through the origin O of the Cartesian coordinate system. These partial distances cₑ form half-lengths of the focal point spacing. The half-length of the major axis of the ellipse is designated a, and the half-length of the minor axis of the ellipse is designated b. The linear eccentricity e is determined from the difference between the square of half the length of the major axis (a) and the square of half the length of the minor axis (b). The half parameter pₑ of the ellipse designates half the length of the distance of the chord drawn parallel to the minor axis through a focal point of the ellipse. The coordinates xₑ and yₑ identify a point on the elliptical curve 50.

The spacing of the vertex P1 of the parabola from the abscissa x is designated cₚ. In the illustrated configuration of ellipse and parabola, the spacing cₚ of the vertex P1 of the parabola from the abscissa x is equal to half the length a of the major axis of the ellipse. The numerical eccentricity eₚ of the parabola is 1. The half parameter pₚ of the parabola designates half the length of the distance of the chord drawn through the focal point P2 of the parabola and at right angles to the ordinate y. The coordinates xₚ and yₚ identify a point on the parabolic curve 51.

We claim:

1. A lightwave oven, comprising:
a lightwave heating device having:
at least one radiant lamp; and
at least one reflector having a reflective surface in a geometric shape formed by a generatrix;
said generatrix having a curve lying between:
an elliptical curve having a first vertex and a first focal point; and
a parabolic curve having a second vertex and a second focal point;
said first and second vertices lying at a common first point; and
said first and second focal points lying at a common second point.

2. The lightwave oven according to claim 1, wherein said generatrix has curve points defined according to the formula:
Xᵣ=Xₑ and Yᵣ=(f*Yₑ+g*Yₚ)/(f+g), where: f>0; g>0; and (f+g)>1.

3. The lightwave oven according to claim 1, wherein said at least one reflector is disposed with respect to said radiant lamp to place said radiant lamp at least approximately at said common second point of said generatrix.

4. The lightwave oven according to claim 2, wherein said at least one reflector is disposed with respect to said radiant lamp to place said radiant lamp at least approximately at said common second point of said generatrix.

5. The lightwave oven according to claim 1, wherein said radiant lamp is disposed at least approximately at said common second point.

6. The lightwave oven according to claim 2, wherein said radiant lamp is disposed at least approximately at said common second point.

7. The lightwave oven according to claim 1, wherein:
said radiant lamp is a tubular rod lamp; and
said reflector is a channel-shaped body having a reflective surface in a geometric shape produced by a translational displacement of said generatrix in a direction at right angles to a surface in which said generatrix lies.

8. The lightwave oven according to claim 2, wherein:
said radiant lamp is a tubular rod lamp; and
said reflector is a channel-shaped body having a reflective surface in a geometric shape produced by a translational displacement of said generatrix in a direction at right angles to a surface in which said generatrix lies.

9. The lightwave oven according to claim 1, wherein:
said radiant lamp is a tubular rod lamp; and
said reflector is a channel-shaped body having a reflective surface in a geometric shape defined by a translational displacement of said generatrix in a direction at right angles to a surface in which said generatrix lies.

10. The lightwave oven according to claim 2, wherein:
said radiant lamp is a tubular rod lamp; and
said reflector is a channel-shaped body having a reflective surface in a geometric shape defined by a translational displacement of said generatrix in a direction at right angles to a surface in which said generatrix lies.

11. In a lightwave heating device of a lightwave oven having at least one radiant lamp, a lamp reflector comprising:
at least one reflector body having a reflective surface in a geometric shape formed by a generatrix having a curve lying between:
an elliptical curve having a first vertex and a first focal point; and
a parabolic curve having a second vertex and a second focal point;
said first and second vertices lying at a common first point; and
said first and second focal points lying at a common second point.
